(19) United States
(12) Patent Application Publication
(10) Pub. No.: US 2026/0127666 A1
(43) Pub. Date: May 7, 2026

(54) INTELLIGENT DATASTREAM MERGING LEVERAGING MACHINE LEARNING FOR EXTRACTION, TRANSFORMATION, AND LOADING

(71) Applicant: www.trustScience.com Inc., Edmonton (CA)

(72) Inventors: Mat Lavoie, Edmonton (CA); Pawel Kuras, Edmonton (CA)

(21) Appl. No.: 18/934,809

(22) Filed: Nov. 1, 2024

(51) Int. Cl. G06Q 40/03; G06F 16/25; G06F 16/28

(52) U.S. Cl. CPC G06Q 40/03; G06F 16/254; G06F 16/285

(57) ABSTRACT

Systems and methods are provided for information identification and categorization such that data from a first dataset may be matched to or identified with data from a second dataset through use of a first, unsupervised machine learning algorithm followed by use of a second, rules-based machine learning algorithm. The novel combination of the algorithms to identify, combine, and/or categorize data sets preferably relies upon at least two different data sources that are not fully communicative with one another, such that the information that each data source contains may be a subset of information of the other data source(s). Rules may associate particular items including dates, amounts, text, etc. within the data. One notable application is the creation of a time-based payment expectation. Novel application of machine learning algorithms permits scalable and repeatable processes for the identification and categorization that has not been previously possible within available resource budgets.

### TECHNICAL FIELD

This invention relates generally to the use of machine learning algorithms in serial application to identify and categorize potentially related data from a plurality of data sources which permits, for example, determination of a time-based expected payment burden. More particularly, this invention relates to the field of intelligent datastream merging, leveraging machine learning for entity resolution, extraction, transformation, and loading (“ETL”).

### BACKGROUND

In various contexts, persons or entities seeking to identify and consolidate information, encounter problems that make the identification and categorization of such information difficult when performed with a conventional computer. And use of human labor or intellect to solve the problem is both impractical and untimely due, at least in part, to the large amount of data that must be processed and the compressed times in which such processing must occur.

One specific example of this identification and categorization relates to the combination of a person, family, or company's income data and that same entity's debt data. Specifically, a problem may occur when considering the information disparities between a credit bureau and one or more banks of the entity. The problem includes a common situation in which no single source of a debt profile of an entity currently exists.

Certain information may be available in a credit bureau report that compiles information from certain sources, but not all sources, information from various debts that are outstanding, information regarding payments on such debts, and information regarding whether payments were timely or missed, along with other information that may be relevant in determining whether an entity is expected to be able to pay debts or not. Other information may be available in banking records, such as account balances, account balance history, debits, credits, handwritten check records, electronic check records, as well as information regarding payees, dates, amounts, and other information associated with such checks. This information might be available in similar or different form for handwritten checks versus checks that are issued through an automated payment system or an electronic check payment system. For example, on a handwritten check written in cursive, the bank may not have an OCR capture or other data that accurately portrays the payee name or memo line information that indicates the purpose of the check. Whereas, in electronic payments, such information (if it is included) is often in digital form that was typed at some point by the account holder.

To build the most complete data set, it may be desirable to combine information from both a credit bureau and a bank, and more preferably from multiple credit bureaus and multiple banks where such information is available. It is often the case that banking records hold an incomplete set of data. This might not be true for a person who pays solely through banks, who is up to date with payments on all accounts, and who does not prepay any payments or pay amounts other than the exact balance due in any given payment. However, the situation is very different where persons receive income or make payments outside of the banking system.

Many people may find themselves the recipients of cash payments that are never recorded within a bank. Similarly, such people might make their own cash payments on certain obligations and collect a handwritten paper receipt therefrom. For example, a person might physically present themselves at a utility company, pay in cash, and obtain a receipt for the cash payments without ever interacting with a bank. Such cash payments are also possible with respect to multiple types of accounts where outstanding balances or regularly occurring balances are incurred. Such payments may not be recorded in a bank account's records. In addition to this, people that use banks less frequently may prefer to purchase money orders from various vendors for making payments. Such money orders may be purchased with cash and sent directly to the entity to whom a person has an obligation. And such money orders might never appear on banking records.

Similarly, various persons purchase cashier's checks or other secured methods of payment for paying various obligations without tying such payments to any bank account associated with the person. Thus, it becomes important to identify both credits and debits in banking and to classify them appropriately.

One situation where banking and credit bureau records might further appear inconsistently is a situation where various payments are not shown in full detail. For example, a person may use a credit card, cash, or a check to pay for gasoline for an automobile. Such a payment might not be recorded as a gasoline purchase. In some establishments, it is possible to purchase groceries, gasoline, or automotive repair services in the same facility. A payment to that facility may not register as being specifically related to one category of goods or services or another. Further, there may be situations in which a person makes a mortgage payment, either through a bank account or separate from a bank account, but the person's bank account might not have a simplified notation or data within the account records that indicates that a mortgage payment has been made. In some instances, the payment might not show it all. In other instances. The payment might show as a transfer to a different account or bank. For example, when automatic withdrawals are enabled for a bank account or when automatic payments through wire transfer or other automated system are enabled for a bank account, payments to such accounts might not be easily identified as payments of a mortgage without data from the mortgage holder showing that the monthly payment was received.

It would be desirable to overcome these known problems that exist in identifying and categorizing information.

It would further be desirable to overcome such problems in a manner that is reliably repeatable, objective, and scalable. For example, using collected data, a human might attempt multiple combinations hoping to properly merge and categorize information based on available data points. However, different humans might proceed in different manners according to their own intelligence, training, biases, or other differences. And scaling such tasks from data of a single entity, to one hundred entities, to thousands or millions of entities while being performed by humans results in significant overhead as the orders of magnitude of the numbers of searches increases. Such overhead may be in the form of management, human resources, additional desks and additional buildings for workers, travel time to distribute assignments, coordination of workers, etc.

Similar processes would be desirable for use with data other than banking or credit bureaus data.

In view of the many problems present in existing systems, it is desirable to have a reliably repeatable process and system for identifying, merging and categorizing information in real-time.

It is further desirable to have an objective process and system for identifying, merging and categorizing various types of information in large data sets, in real-time, that is not affected from case to case by a human's (or many humans') biases, education, training, etc.

It is further desirable to have a scalable process and system for identifying, merging, and categorizing information, in real-time, that does not suffer from many of the inefficiencies introduced through the use of known systems by humans.

It is further desirable to have an explainable process and system for identifying, merging, and categorizing information, in real-time, that does not rely upon the vagaries of decision making in a less logical environment.

The above-described deficiencies are merely intended to provide an overview of some of the problems of conventional systems and methods and are not intended to be exhaustive. Other problems with conventional systems and corresponding benefits of the various non-limiting embodiments described herein may become further apparent upon review of the following description.

### SUMMARY

The following presents a simplified summary of the specification to provide a basic understanding of some aspects of the specification. This summary is not an extensive overview of the specification. It is intended to neither identify key or critical elements of the specification nor delineate any scope particular to any embodiments of the specification, or any scope of the claims. Its sole purpose is to present some concepts of the specification in a simplified form as a prelude to the more detailed description that is presented later. The embodiments set forth below are intended to be non-limiting except where such embodiments describe the only manners of achieving the inventive systems and methods.

It is an objective of the inventive systems and methods to provide reliably repeatable processes and systems for identifying, merging, and categorizing information in real-time. Such reliably repeatable nature may be derived in part from using the logical processes set forth herein, rather than over-reliance on the logically fallible processes of the human mind.

It is a further objective of the inventive systems and methods to provide objective processes and systems for identifying, merging, and categorizing information in real-time. Such objectivity may be derived from moving away from processes and systems that rely overly-much on a human's (or many humans') biases, education, training, etc., which may result in non-objective determinations over the course of evaluating a few or many identity inquiries.

It is a further objective of the inventive systems and methods to provide scalable processes and systems for identifying, merging, and categorizing information in real-time. Human labor does not scale well and often scales in an asymptotic manner that approaches a limit based upon the amount of scaling. However, the systems and methods described herein generally scale linearly or substantially linearly in their capabilities to handle additional identity inquiries, and do not generally approach a limit within practical reason. That is, the ability to scale substantially linearly often appears to be almost limitless within the quantity of inquiries that may be needed or used. Such systems and methods do not suffer from many of the inefficiencies introduced through the use of known systems by humans. They can be scaled linearly or substantially linearly within a particular time. That is, if the number of resources and quantity of queries are increased at a 1:1 ratio, then the systems and methods can scale linearly or substantially linearly over time, as opposed to the asymptotic scaling encountered when humans are heavily involved.

It is a further objective of the inventive systems and methods to provide explainable processes and systems for identifying, merging, and categorizing information in real-time. Such systems and methods can provide a set of objective parameters that can be verified by using the same parameters on differing data to test the objectivity. Such objective and explainable processes and systems do not rely upon the vagaries of decision making in a less logical environment. For example, while two humans may be asked to write a description of the decision process used in making a complex decision, it will often be seen that (even in circumstances where both reach the same decision) the explanation of the process employed will vary from decision to decision. The precision level with which the inventive decision-making process can be explained is at a level that humans are not known to be able to accomplish nor approach.

The inventive concepts set forth herein may be realized in various forms including systems, methods and computer-readable media.

In an embodiment, the determination of efficiently matching and merging data in real-time may use a machine learning algorithm, wherein a request to obtain debit and credit data may be sent to a plurality of data sources. Alternatively, information regarding obtaining debit and credit data regarding an individual may be received from a plurality of data sources. This might include first data from a first data source and second data from one or more second data sources. The first data that is obtained from the first data source may include data obtained from a database such as credit data from a credit rating agency or other similar data. The data may include a compilation of data, regarding an individual or an entity. That data might include debt amounts, credit identifiers, expected payment information, actual payment information, and it might include other related data. In the same method, the second data that is obtained from at least the second data source might be obtained from a different database. The second data that is obtained from the second data source might include identification of debits to one or more accounts of an individual or entity. This might include bank account data such as savings account data, checking account data, credit line data, credit card data, or other similar data.

If the data received is unstructured, which is often the case when dealing with various types of data (for example, debit and credit data), it is preferable to first create structure by categorizing the data and extracting the entities from the unstructured data. Such structure creation might require additional procession that might include application of one or more machine learning algorithms and/or application of various rules for creating structure. After the data has been structured, it is preferable to apply an unsupervised machine learning algorithm to both the first data and the second data. The machine learning algorithm may analyze the data and may cluster the first data and the second data. The clustering may be based upon structures or patterns found within the data and may result in a clustered data set. Such clustering is preferably used to group similar results within the data (for example, data relating to payments made to the same entity).

Following the clustering, it is preferable to apply at least one rules-based machine learning model to the clustered data sets for the purpose of unifying the data sets. This portion of the process may be referred to as entity resolution. The rules-based machine learning model may determine a time-based expected payment burden for the individual or entity. That time-based expected payment burden may then be output in a manner such that it may be used by another individual, device, system, or storage for future use. In some instances, the first data source may be a credit bureau. In such instances, the first data may include data identifying the expected frequency of payment, most recent payment, overall debt that is due to be paid, missed payments, payments that were timely, payment patterns, or other similar data. In many instances, the second data source may be comprised of a plurality of financial accounts linked to one or more individuals, which may include accounts with multiple banks, multiple accounts within a single bank, or a combination of one or more accounts in each of multiple banks.

In some embodiments, it may be desirable to make an automated decision using a second machine learning algorithm. That decision may consider whether to extend credit to the individual or entity based on data that includes the expected payment burdens that were derived in the previous steps. In such instances, a further step may include publishing an offer of credit to the individual or entity. The rules-based machine learning model may include various types of rules for assisting with data combination.

In at least some embodiments, the time-based expected payment burden for the individual or entity may include indications of monthly payments made by the individual or quarterly payments made by the individual with respect to one or a plurality of debts. The time-based expected payment burden for the individual may also include indications of monthly payments made by the individual based on debits found in the second data. It may also include quarterly payments made by the individual based upon debits in the second data. Such payment information derived from the second data may not correspond to payment information found in the first data. In such cases, the rules may determine the proper manner of handling the debits in the second data for processing in the time-based expected payment burden. In some embodiments the time-based expected payment burden for an individual or entity might also include indications of expected, monthly debits or expected. quarterly debits that are not reflected in the first data.

In addition, further embodiments are directed to other exemplary methods, and associated systems, devices and/or other articles of manufacture that facilitate identifying, merging, and categorizing information, as further detailed herein.

These and other features of the disclosed subject matter are described in more detail below.

### BRIEF DESCRIPTION OF THE DRAWINGS

The devices, components, systems, and methods of the disclosed subject matter are further described with reference to the accompanying drawings in which:

FIG. 1 is an illustrative process for information identification and categorization according to the current invention(s);

FIG. 2 is a block diagram of illustrative components for which identification and categorization may be employed;

FIG. 3 is a block diagram illustrating components of data that may be identified and categorized according to an embodiment of the invention;

FIG. 4 is a block diagram illustrating data that has been identified and categorized according to an embodiment of the invention;

FIG. 5 is an illustration of an exemplary grid that may be used to visualize an embodiment of identification and categorization according to an embodiment of the invention;

FIG. 6 is a block diagram of an illustrative architecture for identification and categorization of information according to an embodiment of the invention; and

FIG. 7 is a block diagram of an illustrative architecture of a computer that may be used in a system or method for identification and categorization of information.

### DETAILED DESCRIPTION OF ILLUSTRATIVE EMBODIMENTS

As described above, conventional processes for handling information and/or categorizing existing information may suffer from arbitrary decision-making and scale poorly when it is necessary or desirable to analyze large data sets, such efforts fail to provide meaningful solutions for identification and categorization of information, and/or are subject to further costs or drawbacks, etc., among other deficiencies.

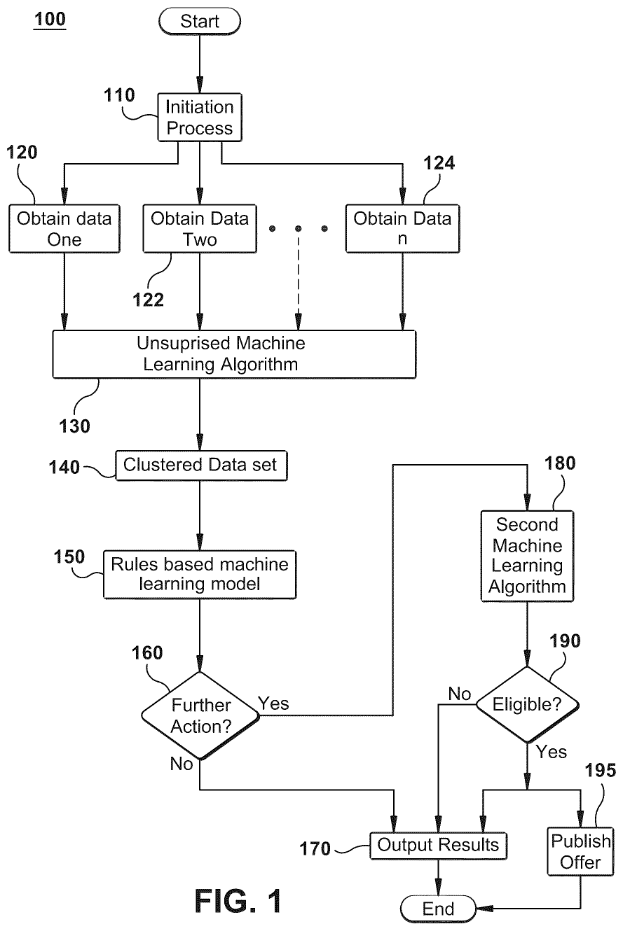

FIG. 1 depicts a simplified flow chart of method 100 of an embodiment of the inventions set for the herein for information identification and categorization. When performing such processes, it may be desirable (or even necessary) to obtain a real-time determination, rather than a determination that takes hours, days, or weeks in various applications. When a decision is to be made in a store selling cellular telephones with a small deposit and a payment plan over time, it may be necessary to perform the inventive process within minutes. When a decision is to be made for a credit card application, it may be necessary to perform the inventive process within hours. And when a decision is to be made for a home equity loan, it may be necessary to perform the inventive process within days or weeks. Each of these is exemplary only, and different processes may have different real-time requirements.

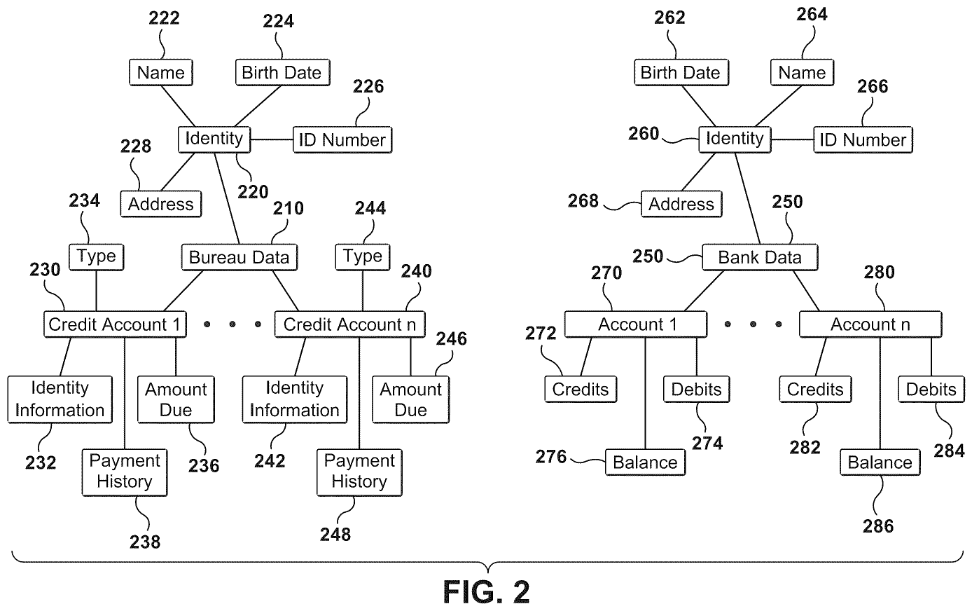

As the process starts and proceeds to step 110, in step 110 an initiation of the inventive system may occur, which may include a request to identify and classify a particular set of information, a request to reach a particular type of output based on whatever data is available, or other types of requests consistent with the principles of the inventions. Where the initiation includes a request and the request is related to determination of commitments and ability to undertake additional commitments, the request may include a plurality of identifiers to identify to the system which data may be relevant. Such identifiers might include some combination of name, address, birth date, identification number, or any of the various types of data set forth below in the discussion of FIG. 2. The request may be transmitted in connection with an inquiry by a user of an application program on a mobile device, by a user of a web browser on a computer, by an automated process being executed by another system, or in many other manners. If the request relates to a human or legal entity, then without some provision of identifiers, processing the request is likely to be largely impossible, so at least some identifiers should be provided.

In steps 120, 122, and/or 124, the process accesses a set of databases quantified by a variable n. This may be as few as two databases (e.g., in the example below it might be a database storing credit bureau information and a database storing banking information). Steps 120, 122, and/or 124 might be performed in parallel, serially, or partially in parallel and partially serial. Step 124 represents that the method may retrieve information from a group of databases numbered n. n may be as low as 2 or may be a much higher number. Such databases may be stored on separate servers, stored on the same server, distributed widely or maintained securely. The databases may be accessed serially or in parallel. It may be necessary to access a number of databases that house various types of data set forth in FIG. 2. For ease of reference, the database of step 120 can be considered to be a database (or group of databases) storing various types of identification credentials for numerous different individuals. In some instances, this might be a credit bureau database, in some instances a credit card database, in some instances a retail seller's database, in some instances a money transfer database, in some instances a database of customers, etc. The database of step 120 may contain multiple types of data from a single category of data or from multiple categories of data (as set forth in FIG. 2). It is possible that the types of data partially or fully overlap for various persons, such as a collection of social security data, credit bureau data, banking payment data, and other financial data.

In step 130, the system may apply an unsupervised machine learning algorithm to the data collected in steps 120, 122, 124 for the purposes of clustering data. Use of an unsupervised machine learning algorithm means that there is no predefined outcome for the data during training.

Various types of unsupervised machine learning algorithms may be used. A non-exhaustive list of such algorithms may include the following. K-means clustering may be used. This clustering algorithm may be used for data segmentation. Principal component analysis or PCA may be used. This algorithm may be used to reduce dimensionality and may also be used in conjunction with K-means clustering. An autoencoder algorithm may be used. This is a type of neural network that uses an input data set and encodes the dataset into a hidden layer prior to decoding and comparison to the original input data set. An autoencoder algorithm may be able to learn complex patterns in data. Alternatively, deep belief networks may be used. A deep belief network creates a hierarchy of layers. Deep belief networks or DBNs may be trained quickly and may work with data sets wherein the amount of labeled data is limited. A restricted Boltzmann machine or RBM may be used. Such an algorithm splits an input data set into two parts, a visible layer and a hidden layer, and is used to learn relationships between input and output layers. Alternatively, a hierarchical temporal memory or HTM may be used. Such algorithms are appropriate for data sets wherein some labeled examples of data exist, but insufficient labels were generated during training of the algorithm. Alternatively, convolutional neural networks or CNNs may be used. CNNs may be able to learn complex relationships between data sets and be trained quickly. CNNs may have disadvantages of high computational requirements which may make training difficult on large data sets. Additionally, CNNs may not work as well with categorical data. Support Vector Machines or SVMs may be used. While SVMs may be used in both unsupervised and supervised learning applications, the application in this embodiment would preferably be related to an unsupervised application. This list of potential algorithms is exemplary only and is not intended to be exhausted.

Application. of the unsupervised machine learning algorithm in Step 130 is intended to result in a clustered data set in step 140. This clustered data set is preferably grouped in various manners identified by the machine learning algorithm. Examples that are relatively straightforward for human application may include clustering payment amounts that are similar or identical in the first data set and the second data set, clustering dates that are similar in the first data set and the second data set, clustering names that are similar in the first data set and the second data set, or clustering other characteristics that are similar or identical in the first data set and the second data set. Additionally, machine learning algorithms may pick up more complex relationships than would be humanly recognizable based on their training and the input data. So, it is not possible to explain or elaborate upon all such relationships that may be identified and used in clustering by the machine learning algorithm in Step 130. In various embodiments of the inventive systems and methods, it may be necessary to perform an initial data clustering process that is restrained to individual data sets, to cluster data separately within individual data sets. In such embodiments, the initial data clustering process may be followed by a process that unifies clusters across two or more data sets. Certain attributes of relevant data might only be determined by considering a pattern over time, and obtaining such patterns might only be possible by clustering data within individual data sets or across data sets. For example, a recurring event that happens on a monthly, quarterly, yearly, or other period might be reflected across different data sets, such that clustering across data sets may provide valuable information.

Following application of the unsupervised machine learning algorithm in step 130 that results in the clustered data set, in step 140, the clustered data set in step 140 may be provided to a rules-based machine learning model in step 150. A rules-based machine learning model is preferably one in which the machine learning method identifies, learns, and/or evolves rules. Those rules may then be stored, manipulated, applied, or otherwise used by the algorithm. This set of rules is a set of relational rules that may represent the knowledge that has been captured by the system through training and through application to various data sets. In an exemplary system wherein credits and debits are being matched in an attempt to determinate time-based expected payment burden for an individual, application of consecutive machine learning algorithms in steps 130 and 150 may allow for resolution of overall payment information in a particular period of time, such as a month, quarter, year, or other relevant period. This may be done by matching payments made by an individual to bills received or to other information in a credit report that indicates expected the payments to be made. For example, the machine learning algorithms may be able to quickly clarify that mortgage payments by the individual are actually mortgage payments and not other types of payment. Such clarification may be very useful in a typical situation wherein credit bureaus hold data that has aged for 3 or 4 months. In situations where the previous three or four months of data may be relevant, but not present in credit reports, the optimized learning process and application to data disclosed in the present invention may prove to be exceedingly useful. Such compilation of data through the clustering and application of rules may make the process much more efficient and resolve problems in data identification that are not resolved through the application of prior art computing solutions. Other problems that may be solved may include data differences wherein many lenders do not report their data to credit bureaus. (In this type of situation, it may be desirable to apply rules-based logic that is not available in a limited machine learning solution. For example, it may be desirable to apply logic not present in a rules-based system for determining why certain data does not match and how such data should be handled.) Often, items that appear in credit bureau reporting similarly do not show up in banking data, for example payments through electronic transfers. This may be indicated differently because an account holder may name the transferee in a convenient manner that can be identified by the account holder but that may not be similar to the name of the actual payee. As one example, an account holder may name an electronic transferee as “mortgage payment,” but the name of the company to whom the payment has been made may be an entirely different name. Similar problems may exist when a person uses a money order to make a payment. Such anomalies may be recognized by machine learning algorithms but may not be recognized by traditional computing systems or by the human mind. Additionally, it is expected that application of machine learning algorithms may result in being able to match patterns and data that a human mind or a traditional computing system may not efficiently match, resulting in much more efficiency in the utilization of computing resources. For example, one may look at data hoping to see a beginning date for payments made over a long period. The machine learning algorithm may recognize the pattern of the payments and the start date, whereas a human may not be able to process the depth of information needed. If payments of a certain type, amount, regularity, and particular date each month are made, but started before a loan payment was due and where the payments have similar or identical amounts to the loan payment amount, a human may miscategorize those payments as pertaining to a particular loan. However, a machine learning algorithm may categorize those payments appropriately as related to a different item because the payments began before the loan was incurred. Similarly, end dates of payments may be viewed in the same manner and the result applied to a series of payments that might otherwise be miscategorized. Where humans are not able to categorize and cluster such data appropriately, machine learning algorithms and rules-based machine learning models, may be able to resolve the issues presented by such data.

Other types of problematic data that may be recognized and resolved by machine learning algorithm may include a reloan by a lender that might not ever appear on credit bureau data but might appear in a payment or in an indication of a balance increasing or decreasing in an amount that is not correlated to any identifiable payment. Similarly, payment amounts may change. A future payment amount may be altered if a payment is missed. Further, identifying a particular type of lender and/or a type of loan might be useful in calculating a time-based expected payment burden. A machine learning algorithm may identify payday lenders based upon training and may also identify longer-term lenders. The ability to apply a reliable, repeatable, and scalable method to such data may result in a decrease in fraud. Currently known systems do not house all such data in a single system, and application of known methods, prior to the inventive method would consume a large, or even phenomenal, amount of networking and processing to identify and classify such data. Thus, the present invention's method of clustering and categorizing data represents an advance in efficiency in both networking and in processing in systems meant for solving problems of the type encountered.

The algorithm of step 130 alone, or in conjunction with the algorithm of step 150, may undertake a process of identifying and grouping multiple transactions, including similar transactions from an individual, similar transactions from a creditor, similar transactions from a debtor, or other data that is clusterable in more complex manners. The algorithms may extract entities from the transactions and perform entity resolution as between the first data and the second data to match banking information from an individual to credit bureau information related to the same individual. Unlike traditional entity resolution in known credit determination algorithms in the prior art, the inventive system and method may involve matching partial names, similar dates, similar or identical payment amounts, estimated interest rate, missed payment patterns, debits and credits that appear to be similar or identical, or other patterns determined by the machine learning algorithms. Metadata about known entities such as a high confidence on the names or the payment size amounts they use then that can be used to improve the accuracy. It is often necessary to address abbreviated lender names from one set of data or another, and possibly differently abbreviated names appearing in both the first data and the second data using metadata on entities. Machine learning algorithms of the type employed here may be useful in such tasks. After such resolution, it is preferred to consider various attributes of both the bank data and the bureau data to develop models to estimate next payment amounts. This is preferably performed by the machine learning algorithms of steps 130 and 150. Various scenarios are preferably encompassed in training data to provide accurate mapping. As mentioned above, in reloan situations, new credit may be issued from an existing lender, loan payment amounts may have changed over time. Loans may be paid off entirely or may be paid off soon. Multiple loans may exist from the same lender, which may be handled separately or together by a debtor. As mentioned previously, late payments may alter the amounts of a single or a subset of future payments, and in some circumstances may impact all future payments. Particular payments may not appear in either the first data set or the second data set, or in both. Such may be the case, as indicated previously, where a debtor uses cash to purchase a money order such that a bank is never engaged or involved with respect to a particular payment that is made with the money order. And, as mentioned above, identification of lenders and types of lenders that do not report to credit bureaus may be obtained from banking data or other data, which may provide a more accurate estimate of types of future payments that are expected in addition to payments that are identified in credit bureau reporting.

After applying the model in Step 150, the method proceeds to decision 160. At decision 160, the system determines whether further action beyond reporting the results is necessary or desired. If no further action is necessary or desired, the method may proceed to step 170, in which the results of the processing are output. Such output may be made in a matter that is machine-readable or human-readable. Such output may be sent as data directly to a database. Alternatively, such output may be provided on the screen of the user. Alternatively, such output may be directed to another individual or entity. The output may be in the form of providing visible data on the screen, providing a file, providing an email, providing a text message, or providing another communication that may be recognizable by a human or computer.

After the output is provided in Step 170, the method of the described embodiment may end.

Alternatively, in step 160, if it is determined that further action is desirable, the method may proceed to step 180, where a second machine learning algorithm is applied to the data that was derived. One example of such a second machine learning algorithm in step 180 might be an algorithm that may be used to determine whether to extend credit to an individual or entity based upon the results obtained through the previously described process. Such an algorithm may be related to a loan for an automobile, a mortgage, a cash loan in a small amount, a loan for a cellular telephone acquisition, or any number of types of extension of credit that may be desirable for the entity or party operating and employing the method and system of this embodiment.

The second machine learning algorithm in step 180 may make a determination, at step 190, whether or not the individual or entity being analyzed is eligible for a further extension of credit. In such an instance, it may be desirable to output the results in step 170, if the person is not eligible for further credit. Alternatively, if the person is eligible for further credit, it may be desirable to both output the results and to proceed to step 195, to publish an offer of credit to the individual. After the publication of an offer of credit, the method may end.

Step 195 may involve publication directly to an individual seeking credit, it may involve publication to an entity from whom the individual has sought credit. It may involve publication to both. Or it may involve publication to a different class of entity or individual. For example, the publication may be provided to a clearing house that provides loan information to individuals from multiple different loan providers. For example, an individual may have used a system employing the method described in FIG. 1 to ask for the best mortgage interest rate for which the individual is qualified. Thus, in step 180, the machine learning algorithm may apply the individuals'characteristics regarding the time-based expected payment burden to multiple sets of criteria from multiple different lenders. That application to multiple sets of criteria for multiple lenders may result in a plurality of different offers of credit from such lenders. For example, one lender may require a 20% down payment and a particular interest rate based upon the individual's time-based expected payment burden. Another lender may require only a 10% down payment but a higher interest rate. Another lender may require the individual to make a particular down payment and to pay a certain number of points on the loan. Yet another lender might require further data, such as income data, job history, or other data, before being able to provide a response to the individual. Thus, in Step 195, it may be desirable to report some or all of such results. It may be desirable to state that further information is required from at least one potential source of credit. It may be desirable to apply a further algorithm that takes into account potential rewards structures to the clearinghouse with respect to providing loans or credit from particular lenders. Or it may be desirable to take other steps prior to providing data directly to lenders or to an individual seeking a loan. In this embodiment, after publication of the offer, the method may proceed to the endpoint in FIG. 1. This does not mean that the entire process of providing a loan is completed, but that the inventive portion of the preferred embodiment disclosed herein has been completed.

In systems used to perform the method set forth in FIG. 1, it is desirable to construct the systems in a manner in which the rate at which the machine learning system 614a, 614b, 614c processes several inquiries can scale substantially linearly over time when new computing resources are added at the same ratio as the number of requests for verification. This provides a substantial advantage for a system in which numerous inquiries might be processed.

FIG. 2 is a block diagram illustrating components 210 through 248 of credit bureau data and components 250 through 286 of bank data in accordance with certain embodiments of the present disclosure. Credit bureau data 210 may include an individual's identity 220, as well as credit accounts 230 through credit account 240. For simplicity of illustration, only two such accounts are shown in the figure, but the number n may represent any reasonable number. And credit bureau data 210 is expected to include data for any reasonable number of relevant accounts. Identity 220 may include data such as name 222, birthdate 224, one or more identification numbers 226, and one or more addresses 228, as well as various other types of identifying information that different credit bureaus may store. Credit account 1 230 may include identity information 232 that may be tied to identity 220 by one or more individual datum. Credit account 1 230 may include indicators of type of account 234, amount due 236, and payment history 238. Similarly, credit account n 240 may also include identity information 242, type of account 244, amount due 246, and payment history 248. Payment history 238 and 248 may include numerous data points that indicate payment dates, payment amounts, missed payments, continuity of payments, sources of payments, and other information that may be useful in determining how creditworthy an individual may be. While not all information collected by a credit bureau is indicated on FIG. 2, for purposes of simplicity, it is understood that credit bureaus compile account information that includes payment history, balance of an account, when an account was opened, date of last activity, high credit on the account, and credit limit on the account. It may also include debt collection information as well as bankruptcies.

Bank data, indicated in FIG. 2, as item 250 may include identity 260 and various accounts 270 and 280. For purposes of simplicity, only two accounts are indicated on FIG. 2, but it should be understood that n may indicate any number of accounts, and that an individual may hold one bank account, two bank accounts, three bank accounts, or any reasonable number of bank accounts. The bank data 250 is expected to include identity 260. The components of identity 260 may include birthdate 262, name 264, identification number 266, and one or more addresses 268. Bank data 250 may also include identity data for multiple persons, if more than one person or entity is listed as an account holder. For the accounts such as account 1, identified as item 270, account data is expected to include credit information 272 and debit information 274, as well as balance information 276. Similarly, for each of the accounts 1 through n, the account is expected to include such information. This is represented, for simplicity, by showing account 280 comprising credits 282, debits 284, and balance 286. While it is expected that balances 276 and 286 are single amounts in most instances, it is expected that credits 272 and 282 as well as debits 274 and 284 will include multiple entries. Such entries may include the date, the amount, the source of a credit, the recipient of a debit, and possibly other information such as transferee or transferor account number, address, abbreviation(s) for name, memo line(s), and other indications that may help to identify the purpose of a credit or debit. The information in FIG. 2 is provided for exemplary purposes only and it is contemplated that other types of credit bureau data 210 and/or bank data 250 may be encountered and fall within the scope of the present invention.

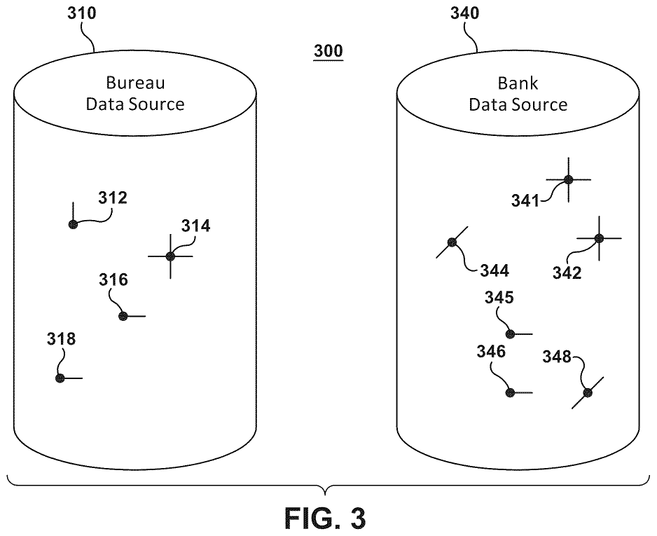

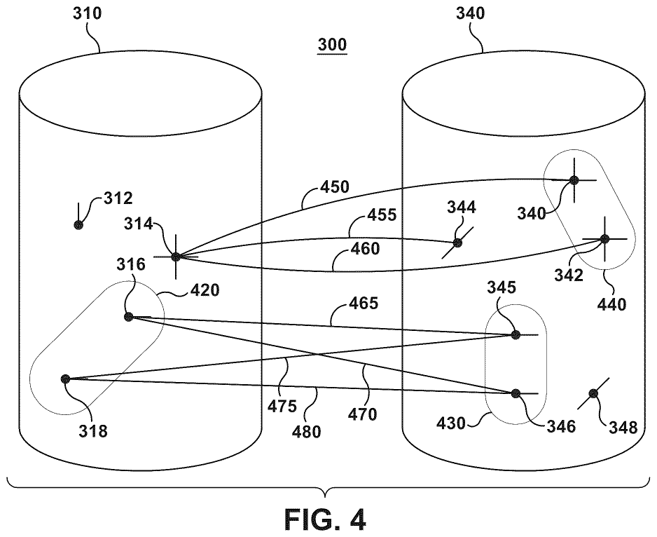

FIGS. 3 and 4 indicate datastores 300 in block diagram form, showing a small number of exemplary data points to illustrate various portions of the inventive system and method. A credit bureau data source 310 is indicated, as well as a bank data source 340. As indicated in this preceding example of an embodiment of the invention, data source 310 may be a first data source corresponding to step 120, and data source 340 may be a second data source corresponding to step 122. As shown within each of the data sources, a small set of data points are indicated, along with illustrative geometric figures that arbitrarily indicate types of data that might be clustered by the present invention's methods and systems. For example, data source 310 includes data points 312, 314, 316, and 318. As can be seen, data points 316 and 318 have similar geometric indicators, whereas each of data points 312 and 314 have different geometric indicators. In the same figure data source 340 includes data points 341, 342, 344, 345, 346, and 348. As can be seen, data points 345 and 346 are the same data type and are also the same type as data points 316 and 318. Similarly, data points 344 and 348 are the same data type, but do not correspond to any data type in datastore 310. And data points 341 and 342 are the same data type which corresponds to the data type of data point 314.

When the unsupervised machine learning algorithm 130 of the inventive method and system is applied to the two data sets, it is expected that various pairings will be created between. data point 316 and each of data points 345 and 346, and that pairings will be created between datapoint 318 and each of data points 345 and 346. It is also expected that such pairings will be given a weighting or a score that is strong enough to indicate that they are of the same data types for use in clustering. Similarly, it is expected that data point 314 will be paired with each of data points 341 and 342, and that strong scores or weights will be given to such pairings to indicate that they are the same type of data point. It is possible that data point 312 may be paired with one of the data points in data source 340. But one might expect that the unsupervised machine learning algorithm 130 would give a weak weight or score to a pairing between 312 and one of the other data points, than to pairings of data points that are of the same type. However, it is also expected that in some instances, a correlation may exist between data point 312 and one of the other data points in data source 340 that might not be recognized by a human and that might be the result of machine learning, such that it might be appropriate to pair 312 with one of the other points from data source 340 with a higher score or weight. Similarly, either of data points 344 or 348 might be paired with a data point from data source 310. But again, because data points 344 and 348 are apparently of a different type than any apparent data in data source 310, one might expect that the score or weighting of the pairing might be lower. It might be possible, in some instances, that data point 314 and data source 310 might be paired with data point 344 in data source 340. These appear to be different types of data, such that one might expect that a lower score or weight would be given to the pairing. But again, a human analyzing this might not recognize a match or pairing that a machine learning algorithm might recognize as significant. In this manner, clustering may be accomplished between data within data source 310 and data in data source 340. As noted, the small number of data points is exemplary. Actual data sets are expected to include much higher numbers of data points, and many different types of data points, such that clustering the data may not be as simple as indicated in FIGS. 3 and 4.

The described pairings are indicated further in FIG. 4, as pairings 465, 470, 475, and 480 that indicate clustering of data points 316, 318, 345, and 346. Similarly, cluster 420 indicates a cluster of data points 316 and 318, while cluster 430 indicates a cluster of data points 345 and 346. Such clusters may be accomplished by the machine learning algorithm. Also indicated in FIG. 4 is cluster 440 of data points 341 and 342, as well as lines 450 and 460 that indicate that datapoint 314 may be clustered with 341 and 342. Also indicated is an exemplary, potential mismatch between 314 and 344, as indicated by line 455. It is possible that this is a mismatch of data and, if so, one would hope or expect that the machine learning algorithm would give this a low score or weight. On the other hand, as noted above, it is possible that this represents a clustering that A human might not recognize but there's a machine learning algorithm might recognize as significant. It is also possible that a single data point might be grouped into multiple clusters. For example, if one data point contained a combination of name, identification number, and phone number, it might be correlated with multiple other data points by the machine learning algorithm and used in multiple clusters. In the disclosed manner, various data within two or more large data sets may be clustered by an unsupervised machine learning algorithm into a number of groupings determined by the machine learning algorithm. One of ordinary skill will understand that there are many ways to store and index such data that will be acceptable for various implementations of the embodiments of the disclosed inventions.

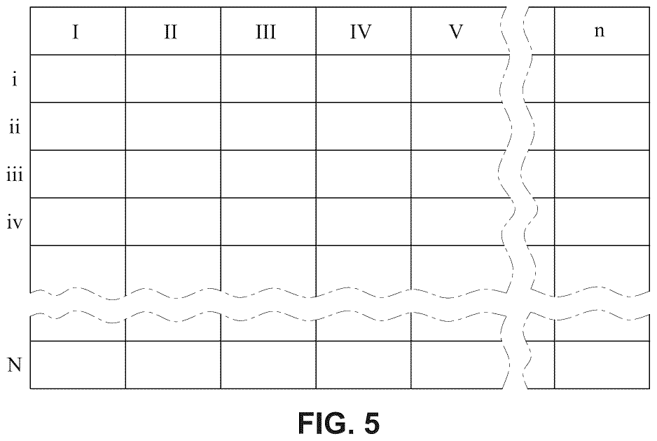

FIG. 5 illustrates an exemplary table that may be used to represent a set of attributes and data points that are being analyzed by one or more machine learning algorithms within an embodiment of the invention. The table shows a set of columns labeled with capital Roman numerals I, II, III, IV, V, through variable n, and a set of rows labeled with lowercase Roman numerals i, ii, iii, iv, and extending through variable N. As the machine learning algorithm clusters data, it may cluster the data using a series of attributes represented by columns labeled with capital Roman numerals 1 through variable n. For example, the columns may relate to principal, amount, and other attributes. The rows may represent various data points and the manner in which they are matched or clustered. Such a representation is exemplary only and may be used by the system to provide a method of reporting the clustering for future analysis of accuracy and/or for replication at a later date. The definition of the most pertinent attributes is an ongoing problem, that's the present invention seeks to improve upon and/or solve. For example, only certain attributes may be obtained from credit bureau data, based upon its limitations. On the other hand, while banking data has a richer set of possible attributes that includes dollar amounts, account names, etcetera, such banking data might only extend back one year from the date at which the analysis is performed. On the other hand, credit bureau data might go back further, providing advantages with respect to the data that is stored by the credit bureau. Thus, because of the different expected scope of data over time, it is expected that, at times, data from credit bureau data sources will not match or easily cluster with data obtained from bank data sources. Thus, the two types of data may result in very different findings with respect to a time-based expected payment burden. And the combination of data within the inventive systems and methods disclosed herein may result in a more accurate finding than the consideration of either type of data alone.

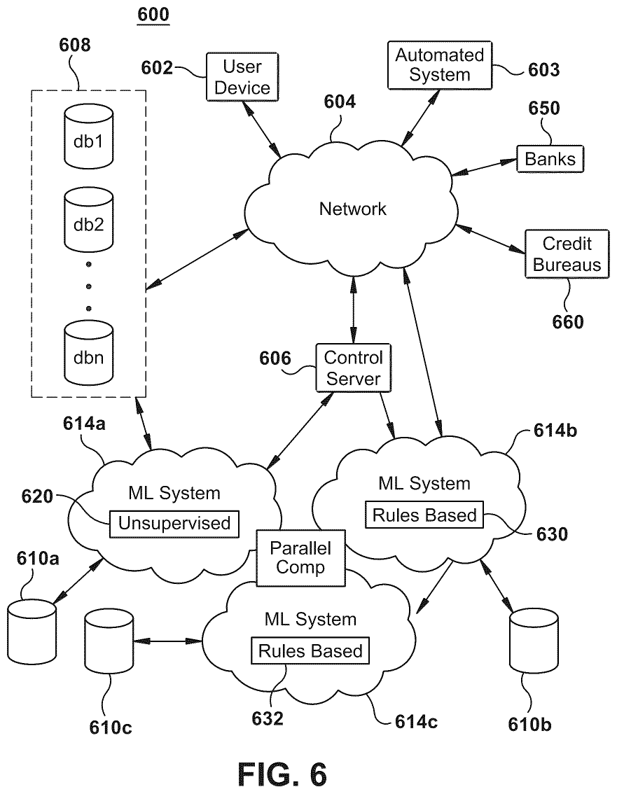

FIG. 6 depicts a functional block diagram illustrating an exemplary environment 600 suitable for use with aspects of the disclosed subject matter. For instance, it depicts an exemplary set of devices, parties or participants communicatively coupled to each other and involved in the provision, collection, use, and distribution of identity information. For example, a user device 602 can provide and receive information, through communication network 604, to and from other devices communicatively coupled to communication network 604.

A user device 602 may be a hardware device and may comprise a computer application. Though only one user device 602 is depicted, it is to be understood that in many networks it is possible to connect and communicate with multiple user devices 602. User device 602 may be communicatively coupled to network 604 via wired, wireless, or combination connections. As a non-limiting example, user device 602 may be a mobile or stationary computer, a mobile phone, an augmented reality device, or other such hardware as may become available and allow such communication.

Automated system 603 may also provide and receive information, through network 604, to and from other devices communicatively coupled to the network 604. Automated system 603 may be a system that is largely or wholly controlled by an artificial intelligence (“AI”) or machine learning (“ML”) algorithm, or system 603 may be largely or wholly controlled by a human or other non-learning computer systems.

Similar to user device 602, automated system 603 may be a hardware device and may comprise a computer application. Though only one automated system 603 is depicted, it is to be understood that in many networks it is possible to connect and communicate with multiple automated systems 603. Automated system 603 may be communicatively coupled to network 604 via wired, wireless, or combination connections. As a non-limiting example, automated system 603 may be a mobile or stationary computer, a mobile phone, an augmented reality device, or other such hardware as may become available and allow implementation of such systems with communication.

Additional systems such as bank system(s) 650 and/or credit bureau system(s) 660 may be communicatively coupled with network 604 and, through network 604, with one or more of the other devices and/or systems illustrated in environment 600. Bank system(s) 650 and credit bureau system(s) 660 have their own complex security and interface systems, a discussion of which is beyond the scope of this disclosure. Thus, such systems may be treated as interacting in largely the same manner as the other components for purposes of the discussion herein, while keeping in mind that such systems will have complex security and interface issues.

Control server 606 may comprise a suitable computer server which may include a web server, file server, or other server along with appropriate control mechanisms. Control server 606 may be configured to receive data including control requests or commands from user device 602 and/or automated system 603. Such requests or commands may be conveyed via network 604.

Data store 608 may be connected communicatively to control server 606, network 504, and/or machine learning system 614a, 614b, and/or 614c. Training data stores 610a, 610b, 610c are preferably communicatively coupled to at least machine learning system 614a, 614b, 614c, respectively. It is possible that all machine learning systems 614a, 614b, 614c would use the same training data or different training data and, thus, an option with three repositories of training data is illustrated.

Machine learning systems 614a, 614b, 614c may be implemented using various frameworks and, rather than being implemented separately, may be implemented using a single framework. Preferably a parallel processing framework 640 is employed. As illustrated, a single parallel processing framework or components thereof may be used to implement each of systems 614a, 614b, 614c. Within the scope of certain embodiments of the invention, it may be desirable to first apply an unsupervised machine learning algorithm 620 to data from multiple data sources, e.g., db1, db2, or any of the databases from 1 to n as illustrated in data store 610. It may also be desirable to communicate through control server 606 and network 604 to obtain data directly from bank system(s) 650 and/or credit bureau system(s) 660. Such an algorithm 620 is preferably used to analyze and cluster data from a first data source and a second data source based on structures or patterns in the data.

It may be further desirable that the results of algorithm 620 be passed to machine learning system 614b for application of a rules-based machine learning model 630 to the data for purposes of making a determination from such data. One example of a determination that might be made is a time-based expected payment burden for an individual.

Following the making of a determination, it may be desirable to apply yet another machine learning algorithm 632 in machine learning system 614c to make a further determination based on the application of rules to the output of system 614b. One such determination might be a decision as to whether credit should be extended to an individual.

Communication network 604 may include wired and/or wireless network components, such as the Internet, cellular, or local area wireless networks. Communication network 604 may also include networks such as Bluetooth and infrared networks. Communications on communications network 604 may be encrypted or otherwise secured using any suitable security or encryption protocol.

Control server 606, which may include any network server or virtual server, such as a file or web server, may access data sources db1 . . . dbn in data store 608 locally or over a suitable network connection such as network 604. Control server 606 may also include processing circuitry (e.g., one or more computer processors or microprocessors), memory (e.g., RAM, ROM, and/or hybrid types of memory), and one or more storage devices (e.g., hard drives, optical drives, flash drives, etc.). The processing circuitry included in control server 606 may execute processors capable of executing various processes in parallel. Server 606 may be able to receive, process, and distribute information generated by an application executing on a user device 602, such as a computer or a mobile device (e.g., a cell phone, a wearable mobile device such as an augmented reality device, etc.). The processing circuitry included in control server 606 may also perform a host of calculations and computations that may be needed in managing and determining continuous identity. In some embodiments, a computer-readable medium with computer program logic recorded thereon is included within control server 606. The computer program logic may perform various of the steps described herein with respect to identity determination.

Control server 606 may access data sources in data store 608 over the Internet, a secured private LAN, or other communications network. Data sources in data store 608 may include one or more third-party data sources, such as data from banks, credit bureaus, other sources of data reflected in FIG. 2, or other relevant sources. For example, data sources in data store 608 may include retailers, credit card processors, or various information services. Data sources in data store 608 may also include data stores and databases local to control server 606.

Control server 606 may be in communication with machine learning systems 614a, 614b, 614c. Machine learning systems 614a, 614b, 614c, which may include any parallel or distributed computational framework or cluster 640, may be configured to divide computational jobs into smaller jobs to be performed simultaneously, in a distributed fashion, or both. For example, machine learning systems 614a, 614b, 614c may support data-intensive distributed applications by implementing a map/reduce computational paradigm where the applications may be divided into a plurality of small fragments of work, each of which may be executed or re-executed on any core processor in a cluster of cores. A suitable example of machine learning systems 614a, 614b, 614c includes an Apache Hadoop cluster.

Machine learning systems 614a, 614b, 614c may interface with training data stores 610a, 610b, 610c and/or data store 608, which also may take the form of a cluster of cores. For example, machine learning systems 614a, 614b, 614c may express a large, distributed computation as a sequence of distributed operations on data sets by dividing the operations into jobs. Such jobs may be executed across a plurality of nodes in the cluster of parallel computational framework 640. The processing and computations described herein may be performed, at least in part, by any type of processor or combination of processors. For example, various types of quantum processors (e.g., solid-state quantum processors and light-based quantum processors), artificial neural networks, and the like may be used to perform massively parallel computing and processing.

Machine learning systems 614a, 614b, 614c may distribute the many tasks across a cluster of nodes and provide the appropriate fragment of intermediate data to each task.

Tasks in each phase may be executed in a fault-tolerant manner, so that if one or more nodes fail during a computation the tasks assigned to such failed nodes may be redistributed across the remaining nodes. This behavior may allow for load balancing and for failed tasks to be re-executed with low runtime overhead.

Data sources in data store 608 and training data stores 610a, 610b, 610c may implement any distributed file system capable of storing large files reliably. For example, they may implement Hadoop's own distributed file system (DFS) or a more scalable column-oriented distributed database, such as HBase, or other data storage and analysis systems such as Google BigQuery, Apache Spark, Snowflake, etc. Such file systems or databases may include BigTable-like capabilities, such as support for an arbitrary number of table columns.

Although FIG. 6, in order to not over-complicate the drawing, only shows a single instance of user device 602, automated system 603, communications network 604, control server 606, data store 608, training data 610a, 610b, 610c, bank system(s) 650, credit bureau system(s) 660, and machine learning systems 614a, 614b, 614c, in practice, architecture 600 may include multiple instances of one or more of the foregoing components. In addition, certain elements may also be removed, in some embodiments.

To provide additional context for various embodiments described herein, FIG. 7 and the following discussion are intended to provide a brief, general description of a suitable computing environment 700 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that portions of the inventive methods can be practiced with other computer system configurations, including single-processor or multiprocessor computer systems, minicomputers, mainframe computers, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CDROM), digital versatile disk (DVD), Blu-ray disc (BD) or other optical disk storage, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media. With reference again to FIG. 7, the example environment 700 for implementing various embodiments of the aspects described herein includes a computer 702, the computer 702 including a processing unit 704, a system memory 706 and a system bus 708. The system bus 708 couples system components including, but not limited to, the system memory 706 to the processing unit 704. The processing unit 704 can be any of various commercially available processors. Dual microprocessors and other multiprocessor architectures can also be employed as the processing unit 704.

The system bus 708 can be any of several types of bus structure that can further interconnect to a memory bus (with or without a memory controller), a peripheral bus, and a local bus using any of a variety of commercially available bus architectures. The system memory 706 includes ROM 710 and RAM 712. A basic input/output system (BIOS) can be stored in a non-volatile memory such as ROM, erasable programmable read only memory (EPROM), EEPROM, which BIOS contains the basic routines that help to transfer information between elements within the computer 702, such as during startup. The RAM 712 can also include a high-speed RAM such as static RAM for caching data.

The computer 702 further includes an internal hard disk drive (HDD) 714 (e.g., EIDE, SATA), one or more external storage devices 716 (e.g., a magnetic floppy disk drive (FDD) 716, a memory stick or flash drive reader, a memory card reader, etc.) and an optical disk drive 720 (e.g., which can read or write from a CD-ROM disc, a DVD, a BD, etc.). While the internal HDD 714 is illustrated as located within the computer 702, the internal HDD 714 can also be configured for external use in a suitable chassis (not shown). Additionally, while not shown in environment 700, a solid-state drive (SSD) could be used in addition to, or in place of, an HDD 714. The HDD 714, external storage device(s) 716 and optical disk drive 720 can be connected to the system bus 708 by an HDD interface 724, an external storage interface 726 and an optical drive interface 728, respectively. The interface 724 for external drive implementations can include at least one or both Universal Serial Bus (USB) and Institute of Electrical and Electronics Engineers (IEEE) 794 interface technologies. Other external drive connection technologies are within contemplation of the embodiments described herein.

The drives and their associated computer-readable storage media provide nonvolatile storage of data, data structures, computer-executable instructions, and so forth. For the computer 702, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 712, including an operating system 730, one or more application programs 732, other program modules 734 and program data 736. All or portions of the operating system, applications, modules, and/or data can also be cached in the RAM 712. The systems and methods described herein can be implemented utilizing various commercially available operating systems or combinations of operating systems.

Computer 702 can optionally comprise emulation technologies. For example, a hypervisor (not shown) or other intermediary can emulate a hardware environment for operating system 730, and the emulated hardware can optionally be different from the hardware illustrated in FIG. 7. In such an embodiment, operating system 730 can comprise one virtual machine (VM) of multiple VMs hosted at computer 702. Furthermore, operating system 730 can provide runtime environments, such as the Java runtime environment or the . NET framework, for applications 732. Runtime environments are consistent execution environments that allow applications 732 to run on any operating system that includes the runtime environment. Similarly, operating system 730 can support containers, and applications 732 can be in the form of containers, which are lightweight, standalone, executable packages of software that include, e.g., code, runtime, system tools, system libraries and settings for an application.

A user can preferably enter commands and information into the computer 702 through one or more wired/wireless input devices, e.g., a keyboard 738, a touch screen 740, and a pointing device, such as a mouse 742. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 704 through an input device interface 744 that can be coupled to the system bus 708, but can be connected by other interfaces, such as a parallel port, an IEEE 1394 serial port, a game port, a USB port, an IR interface, a BLUETOOTH® interface, etc.

A monitor 746 or other type of display device can also be connected to the system bus 708 via an interface, such as a video adapter 748. In addition to the monitor 746, a computer typically includes other peripheral output devices (not shown), such as speakers, printers, etc.

The computer 702 can operate in a networked environment using logical connections via wired and/or wireless communications to one or more remote computers, such as a remote computer(s) 750. The remote computer(s) 750 can be a workstation, a server computer, a router, a personal computer, portable computer, microprocessor-based entertainment appliance, a peer device or other common network node, and typically includes many or all of the elements described relative to the computer 702, although, for purposes of brevity, only a memory/storage device 752 is illustrated. The logical connections depicted include wired/wireless connectivity to a local area network (LAN) 754 and/or larger networks, e.g., a wide area network (WAN) 756. Such LAN and WAN networking environments are commonplace in offices and companies, and facilitate enterprise-wide computer networks, such as intranets, all of which can connect to a global communications network, e.g., the Internet.

When used in a LAN networking environment, the computer 702 can be connected to the local network 754 through a wired and/or wireless communication network interface or adapter 758. The adapter 758 can facilitate wired or wireless communication to the LAN 754, which can also include a wireless access point (AP) disposed thereon for communicating with the adapter 758 in a wireless mode.

When used in a WAN networking environment, the computer 702 can include a modem 760 or can be connected to a communications server on the WAN 756 via other means for establishing communications over the WAN 756, such as by way of the Internet. The modem 760, which can be internal or external and a wired or wireless device, can be connected to the system bus 708 via the input device interface 744. In a networked environment, program modules depicted relative to the computer 702 or portions thereof, can be stored in the remote memory/storage device 752. It will be appreciated that the network connections shown are examples and other means of establishing a communications link between the computers can be used.

When used in either a LAN or WAN networking environment, the computer 702 can access cloud storage systems or other network-based storage systems in addition to, or in place of, external storage devices 716 as described above. Generally, a connection between the computer 702 and a cloud storage system can be established over a LAN 754 or WAN 756 e.g., by the adapter 758 or modem 760, respectively. Upon connecting the computer 702 to an associated cloud storage system, the external storage interface 726 can, with the aid of the adapter 758 and/or modem 760, manage storage provided by the cloud storage system as it would other types of external storage. For instance, the external storage interface 726 can be configured to provide access to cloud storage sources as if those sources were physically connected to the computer 702.

The computer 702 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

It can be further understood that while a brief overview of exemplary systems, methods, scenarios, and/or devices has been provided, the disclosed subject matter is not so limited. Thus, it can be further understood that various modifications, alterations, addition, and/or deletions can be made without departing from the scope of the embodiments as described herein. Accordingly, similar non-limiting implementations can be used, or modifications and additions can be made to the described embodiments for performing the same or equivalent function of the corresponding embodiments without deviating therefrom.

One of ordinary skill in the art can appreciate that the various embodiments of the disclosed subject matter and related systems, devices, and/or methods described herein can be implemented in connection with various computer or other client or server device, which can be deployed as part of a communications system, a computer network, and/or in a distributed computing environment, and can be connected to any kind of data store. In this regard, the various embodiments described herein can be implemented in several types of computer system or environment having any number of memory or storage units, and many applications and processes occurring across any number of storage units or volumes, which may be used in connection with communication systems using the techniques, systems, and methods in accordance with the disclosed subject matter. The disclosed subject matter can apply to an environment with server computers and client computers deployed in a network environment or a distributed computing environment, having remote or local storage. The disclosed subject matter can also be applied to standalone computing devices, having programming language functionality, interpretation and execution capabilities for generating, receiving, storing, and/or transmitting information in connection with remote or local services and processes.

Distributed computing provides sharing of computer resources and services by communicative exchange among computing devices and systems. These resources and services can include the exchange of information, cache storage and disk storage for objects, such as files. These resources and services can also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices can have applications, objects or resources that may utilize disclosed and related systems, devices, and/or methods as described for various embodiments of the subject disclosure.

Those skilled in the art will recognize that it is common within the art to describe devices and/or processes in the fashion set forth herein, and thereafter use engineering practices to integrate such described devices and/or processes into systems. That is, at least a portion of the devices and/or processes described herein can be integrated into a system via a reasonable amount of experimentation. Those having skill in the art will recognize that a typical system can include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control device (e.g., feedback for sensing position and/or velocity; control devices for moving and/or adjusting parameters). A typical system can be implemented utilizing any suitable commercially available components, such as those typically found in data computing/communication and/or network computing/communication systems.

Various embodiments of the disclosed subject matter sometimes illustrate different components contained within, or connected with, other components. It is to be understood that such depicted architectures are merely exemplary, and that, in fact, many other architectures can be implemented which achieve the same and/or equivalent functionality. In a conceptual sense, any arrangement of components to achieve the same and/or equivalent functionality is effectively “associated” such that the desired functionality is achieved. Hence, any two components herein combined to achieve a particular functionality can be seen as “associated with” each other such that the desired functionality is achieved, irrespective of architectures or intermediary components. Likewise, any two components so associated can also be viewed as being “operably connected,” “operably coupled,” “communicatively connected,” and/or “communicatively coupled,” to each other to achieve the desired functionality, and any two components capable of being so associated can also be viewed as being “operably couplable” or “communicatively couplable” to each other to achieve the desired functionality. Specific examples of operably couplable or communicatively couplable can include, but are not limited to, physically mateable and/or physically interacting components, wirelessly interactable and/or wirelessly interacting components, and/or logically interacting and/or logically interactable components.

With respect to substantially any plural and/or singular terms used herein, those having skill in the art can translate from the plural to the singular and/or from the singular to the plural as can be appropriate to the context and/or application. The various singular/plural permutations may be expressly set forth herein for the sake of clarity, without limitation.

It will be understood by those skilled in the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes, but is not limited to,” etc.). It will be further understood by those skilled in the art that, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limit any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include, but not be limited to, systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those skilled in the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible sub-ranges and combinations of sub-ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into sub-ranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be noted that various embodiments of the disclosed subject matter have been described herein for purposes of illustration, and that various modifications may be made without departing from the scope and spirit of the subject disclosure. Accordingly, the various embodiments disclosed herein are not intended to be limiting, with the true scope and spirit being indicated by the appended claims.

In addition, the words “exemplary” and “non-limiting” are used herein to mean serving as an example, instance, or illustration. For the avoidance of doubt, the subject matter disclosed herein is not limited by such examples. Moreover, any aspect or design described herein as “an example,” “an illustration,” “exemplary” and/or “non-limiting” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements, as described above.

As mentioned, the various techniques described herein can be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a computer and the computer can be a component. In addition, one or more components can reside within a process and/or thread of execution and a component can be localized on one computer and/or distributed between two or more computers.

Systems described herein can be described with respect to interaction between several components. It can be understood that such systems and components can include those components or specified sub-components, some of the specified components or sub-components, or portions thereof, and/or additional components, and various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and that any one or more middle component layers, such as a management layer, can be provided to communicatively couple to such sub-components in order to provide integrated functionality, as mentioned. Any components described herein can also interact with one or more other components not specifically described herein but generally known by those of skill in the art.

As mentioned, in view of the exemplary systems described herein, methods that can be implemented in accordance with the described subject matter can be better appreciated with reference to the flowcharts of the various figures and vice versa. While for purposes of simplicity of explanation, the methods can be shown and described as a series of blocks, it is to be understood and appreciated that the claimed subject matter is not limited by the order of the blocks, as some blocks can occur in different orders and/or concurrently with other blocks from what is depicted and described herein. Where non-sequential, or branched, flow is illustrated via flowchart, it can be understood that various other branches, flow paths, and orders of the blocks, can be implemented which achieve the same or a similar result. Moreover, not all illustrated blocks can be required to implement the methods described hereinafter.

While the disclosed subject matter has been described in connection with the disclosed embodiments and the various figures, it is to be understood that other similar embodiments may be used, or modifications and additions may be made to the described embodiments for performing the same function of the disclosed subject matter without deviating therefrom. Furthermore, multiple processing chips or multiple devices can share the performance of one or more functions described herein, and similarly, storage can be affected across a plurality of devices. In other instances, variations of process parameters (e.g., configuration, number of components, aggregation of components, process step timing and order, addition and/or deletion of process steps, addition of preprocessing and/or post-processing steps, etc.) can be made to further optimize the provided structures, devices and methods, as shown and described herein. In any event, the systems, structures and/or devices, as well as the associated methods described herein have many applications in various aspects of the disclosed subject matter, and so on. Accordingly, the invention should not be limited to any single embodiment, but rather should be construed in breadth, spirit and scope in accordance with the appended claims.

What is claimed is:

1. A system for efficiently matching and merging data comprising:
a first datastore on a first server that includes a compilation of data regarding an individual that includes debt amounts, credit identifiers, expected payment information, and actual payment information;
a second datastore on one or more second servers that each include data that identifies debits to an account of the individual;
a data compilation server containing instructions for executing a data compilation engine for obtaining debit and credit data regarding the individual from the first datastore and the second datastore;
a parallel processing system containing instructions for executing and applying unsupervised machine learning algorithms to debit and credit data obtained by the data compilation engine to analyze and cluster the first data and the second data based upon structures or patterns, resulting in a clustered data set;
a parallel processing system containing instructions for applying at least one rules-based machine learning model to the clustered data set to determine a time-based expected payment burden for the individual; and
an output device for outputting the time-based expected payment burden for the individual.

2. The system of claim 1, wherein the first datastore houses credit bureau data and the first datastore includes data identifying at least one expected frequency of payment and at least one most recent payment by the individual.

3. The system of claim 1, wherein the second datastore comprises data regarding a plurality of financial accounts linked to the individual.

4. The system of claim 1, further comprising:
a parallel processing system making an automated decision, using a second machine learning algorithm, whether to extend credit to the individual based on data including the expected payment burdens for the individual; and
an output device for publishing to the individual an offer of credit.

5. The system of claim 1, wherein the instructions for applying at least one rules-based machine learning model include instructions for applying:
at least one rule for associating similar dates in first data and second data;
at least one rule for associating similar amounts in first data and second data; and
at least one rule for associating similar text in first data and second data.

6. The system of claim 1, wherein the time-based expected payment burden for the individual includes:
indications of monthly or quarterly actual payments made by the individual with respect to a plurality of debts; and
indications of monthly or quarterly actual payments made by the individual based upon debits in the second data that do not correspond to actual payment information in the data obtained from the first datastore.

7. The system of claim 6, wherein the time-based expected payment burden for the individual further includes indications of expected monthly or quarterly debits that are not reflected in data obtained from the first datastore.

8. A method to efficiently match and merge data comprising:
obtaining debit and credit data regarding an individual from a plurality of data sources including first data from a first data source and second data from at least one second data source,
wherein the first data obtained from the first data source includes a compilation of data regarding the individual that includes debt amounts, credit identifiers, expected payment information, and actual payment information,
wherein the second data obtained from the at least one second data source identifies debits to one or more accounts of the individual;
applying unsupervised machine learning algorithms to the first data and the second data to analyze and cluster the first data and the second data based upon structures or patterns, resulting in a clustered data set;
applying at least one rules-based machine learning model to the clustered data set to determine a time-based expected payment burden for the individual; and
outputting the time-based expected payment burden for the individual.

9. The method of claim 8, wherein the first data source is a credit bureau and the first data includes data identifying at least one expected frequency of payment and at least one most recent payment by the individual.

10. The method of claim 8, wherein the at least one second data source comprises a plurality of financial accounts linked to the individual.

11. The method of claim 8, further comprising:
making an automated decision, using a second machine learning algorithm, whether to extend credit to the individual based on data including the expected payment burdens for the individual; and
publishing to the individual an offer of credit.

12. The method of claim 8, wherein at least one of the at least one rules-based machine learning model includes:
at least one rule for associating similar dates in first data and second data;
at least one rule for associating similar amounts in first data and second data; and
at least one rule for associating similar text in first data and second data.

13. The method of claim 8, wherein the time-based expected payment burden for the individual includes:
indications of monthly or quarterly actual payments made by the individual with respect to a plurality of debts; and
indications of monthly or quarterly actual payments made by the individual based upon debits in the second data that do not correspond to actual payment information in the first data.

14. The method of claim 13, wherein the time-based expected payment burden for the individual further includes indications of expected monthly or quarterly debits that are not reflected in the first data.

15. A non-transitory computer-readable storage medium comprising:
instructions that, when executed by a device comprising processor, facilitate performance of operations comprising:
obtaining debit and credit data regarding an individual from a plurality of data sources including first data from a first data source and second data from at least one second data source,
wherein the first data obtained from the first data source includes a compilation of data regarding the individual that includes debt amounts, credit identifiers, expected payment information, and actual payment information,
wherein the second data obtained from the at least one second data source identifies debits to one or more accounts of the individual;
applying unsupervised machine learning algorithms to the first data and the second data to analyze and cluster the first data and the second data based upon structures or patterns, resulting in a clustered data set;
applying at least one rules-based machine learning model to the clustered data set to determine a time-based expected payment burden for the individual; and
outputting the expected payment burdens for the individual.

16. The medium of claim 15, wherein the first data source is a credit bureau and the first data includes data identifying at least one expected frequency of payment and at least one most recent payment by the individual.

17. The medium of claim 15, wherein the at least one second data source comprises a plurality of financial accounts linked to the individual.

18. The medium of claim 15, further comprising:
making an automated decision, using a second machine learning algorithm, whether to extend credit to the individual based on data including the expected payment burdens for the individual; and
publishing to the individual an offer of credit.

19. The medium of claim 15, wherein at least one of the at least one rules-based machine learning model includes:
at least one rule for associating similar dates in first data and second data;
at least one rule for associating similar amounts in first data and second data; and
at least one rule for associating similar text in first data and second data.

20. The medium of claim 15, wherein the time-based expected payment burden for the individual includes:
indications of monthly or quarterly actual payments made by the individual with respect to a plurality of debts; and
indications of monthly or quarterly actual payments made by the individual based upon debits in the second data that do not correspond to actual payment information in the first data.
